(19) United States
(12) Patent Application Publication
(10) Pub. No.: US 2014/0181309 A1
(43) Pub. Date: Jun. 26, 2014

(54) METHOD AND SYSTEM FOR CLOUD-BASED IDENTITY MANAGEMENT (C-IDM) IMPLEMENTATION

(71) Applicant: Bhumip Khasnabish, Lexington, MA (US)

(72) Inventor: Bhumip Khasnabish, Lexington, MA (US)

(73) Assignee: ZTE USA INC., Richardson, TX (US)

(21) Appl. No.: 14/125,855

(22) PCT Filed: Jun. 14, 2011
(86) PCT No.: PCT/US2012/042408

§ 371 Date: Mar. 6, 2014

Related U.S. Application Data
(60) Provisional application No. 61/496,874, filed on Jun. 14, 2011.

(51) Int. Cl. H04L 5/00

(52) U.S. Cl. CPC H04L 5/0037
USPC 709/226

(57) ABSTRACT

A virtual IDM server is disclosed. In one embodiment, the server utilizes a plurality of shared resources residing on a plurality of computers in one or more computer networks. The server also controls the allocation and usage of said shared resources on a real-time basis. The server further comprises: one or more APIs for receiving messages related to IDM service requests; and one or more APIs for accessing a plurality of said shared resources on a real-time basis during processing of said IDM service requests.

### BACKGROUND

1. Field of Invention

The present invention generally relates to subscriber and user identity management (IDM) implementation. In particular, it relates to a method and system for an IDM implementation that utilizes distributed virtual resources.

2. Background

Generally speaking, identity management (IDM) is a broad administrative area that deals with identifying individuals in a system (such as a country, a network, or an organization) and controlling access to the resources in that system by placing restrictions on the established identities of the individuals. In the field of computer networks, IDM is a term related to how humans are identified and authorized across computer networks. It covers issues such as how users are given an identity, the protection of that identity, and the technologies supporting that protection (e.g., network protocols, digital certificates, passwords, etc.).

Traditionally, the IDM features and functions are implemented in the following two different ways. First, IDM may be implemented on standalone devices called IDM database or IDM server that is directly connected to other servers such as application server, policy server, home subscriber server (HSS), gateway devices, etc., so that these servers can directly request IDM services from the IDM server. Second, IDM may be Integrated in the network infrastructure elements such as (a) Edge Devices (routers, gateways, switches, optical line termination (OLT) equipment, and Internet protocol based Digital Subscriber Line Access Multiplexer (IP-DSLAM), (b) Service Elements like edge/core service control function, (c) Transport Elements like mobility and resource management functions, etc.

A list of IDM features and functions can be found in, for example the 3GPP spec. TS 24.109 (ftp://3gpp.org/Specs/latest/Rel-10/24_series/) and in ITU-T Focus Group on IDM documents (FGIdM,

http://www.itu.int/ITUT/studygroups/com17/fgidm/index.html). The contents of these documents are incorporated in their entirety in this application.

FIG. 1a shows schematically the block diagrams of a current model for IDM implementations. In the diagram, the IDM server 110 is directly connected to other network entities that would be involved in the current IDM implementations. These network elements may include Application servers 120, session control elements 130, service gateway 140, etc. FIGS. 1b-1c schematically depict the signaling flow and the messages exchanged between different network entities that would be involved in the current IDM implementations.

The standalone IDM server 110 receives requests such as requests for identity verification of subscriber and user in order to authenticate access to a transaction or a session-based service. The IDM server 110 may use a pre-determined number of attributes (e.g., service name and location), credentials (e.g., secret codes or biometrics information), and identifier (names, userID, MACId, IP address, geo-location, etc.) to authenticate the access.

It is worth noticing that the IDM server 110 pursuant to current implementations may or may not control the resources for session and media once the user/subscribed has been authenticated. It is possible that policy, quality of service and security requirements may dictate these allocations. The interface between the Signaling elements of IDM and the Media control elements of IDM can be open (standard protocol) or proprietary protocol, and the interface can be point to point or point to multi-point in order to support reliability through distribution of the resource requests.

The major drawback of the current IDM implementations is that they utilize dedicated servers or network infrastructure elements for IDM services. Such implementation of IDM features and functions would bring the following undesirable results:
A. Increase of Service Costs
B. Increase of time required for testing and integration with network
C. Static allocation of resources
D. Less flexibility in repositioning the resources
E. Tighter coupling of computing and communications resources with pre-designed features and functions
F. Reduced opportunity for innovation

By contrast, what the network service providers need in a dynamic and continuously-evolving networking and service development environment are 1) protection of investment, that is, investment in the resources that can be rapidly repurposed for different revenue generating applications and services; and 2) agility and flexibility, that is, deploying the emerging features and function utilizing the same resources that already exist in the network.

The current invention addresses these major issues and therefore, enables the service providers to allocate their budget for computing, communications, and control infrastructure development rather than creating and installing silos of computing and networking gears which very often either remain underutilized or becomes obsolete before reaching the full potential (or providing the full return on investment).

### SUMMARY OF THE INVENTION

This invention discloses a virtual IDM server. The IDM server utilizes a plurality of shared resources residing on a plurality of computers in one or more computer networks. The IDM server also controls the allocation and usage of the shared resources on a real-time basis. The IDM server further comprises one or more APIs for receiving messages related to IDM service requests and one or more APIs for accessing a plurality of said shared resources on a real-time basis during processing of said IDM service requests.

### BRIEF DESCRIPTION OF THE DRAWINGS

Having thus described the invention in general terms, reference will now be made to the accompanying drawings, which are not necessarily drawn to scale, and wherein:

FIG. 1a shows schematically the block diagrams of current models for IDM implementations.

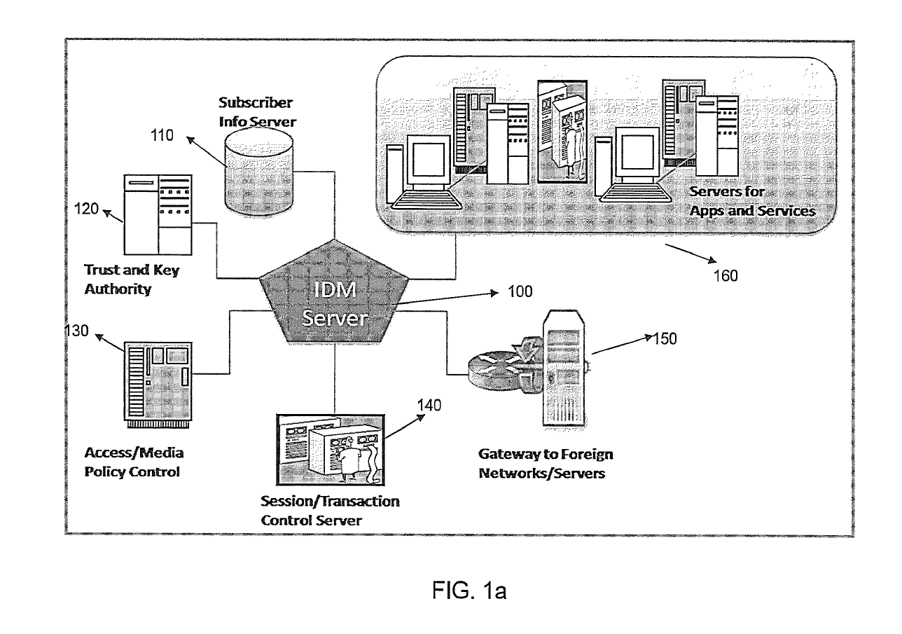

FIG. 1b shows schematically the signaling flow involved in the current IDM implementations.

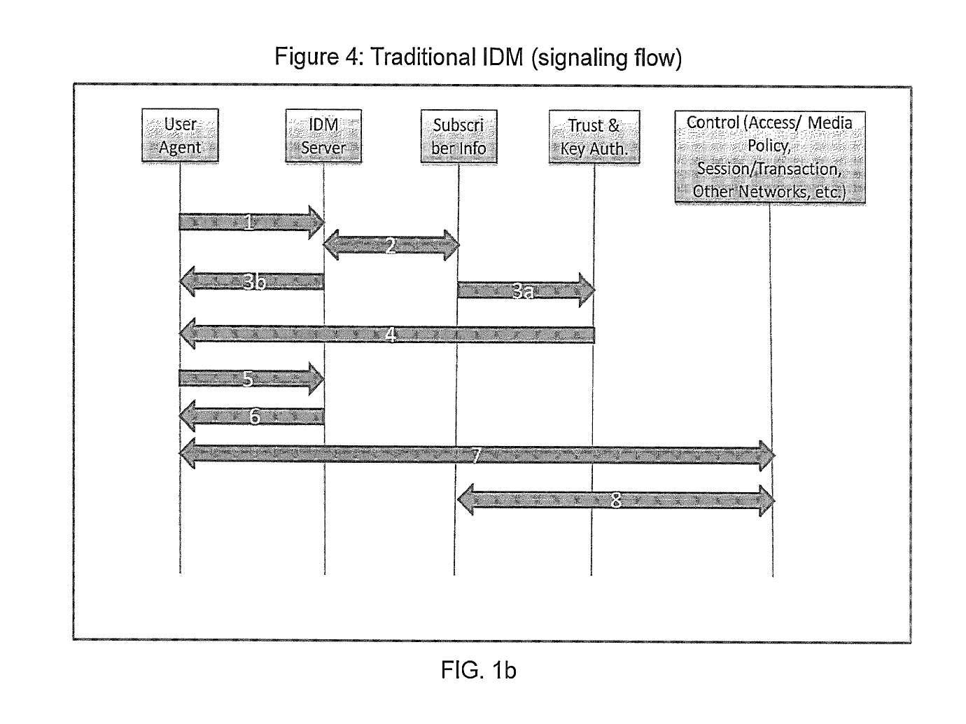

FIG. 1c shows schematically the message exchanges involved in the current IDM implementations.

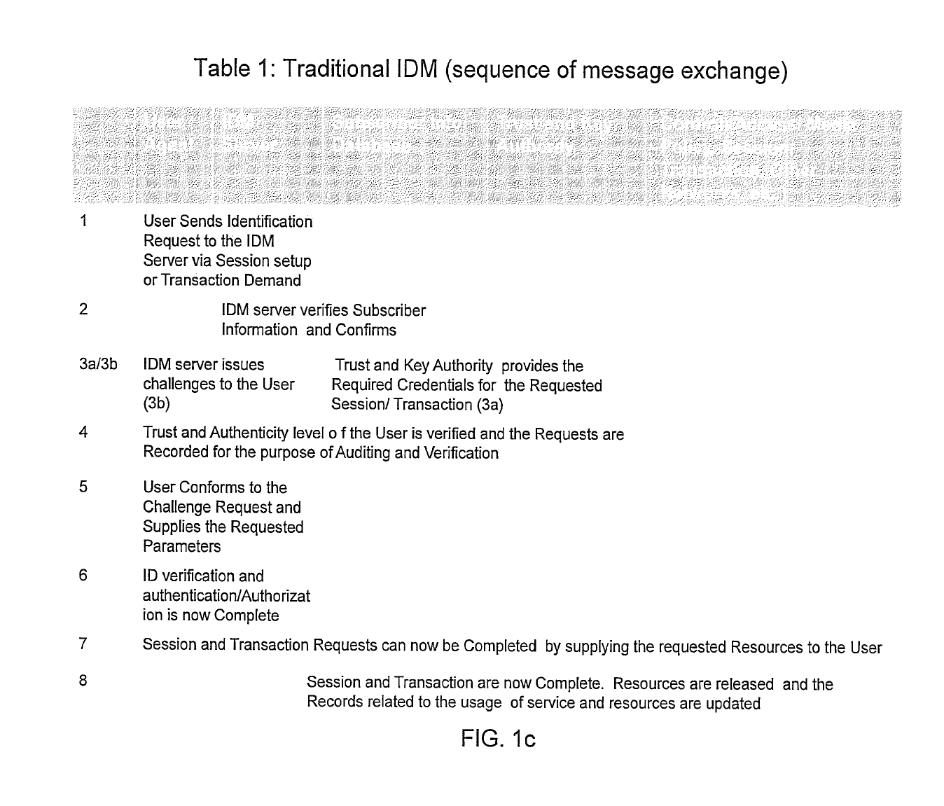

FIG. 2 shows schematically the IDM implementation model in one embodiment of this invention.

FIG. 3 shows schematically a method for providing IDM service in one embodiment of this invention.

### DETAILED DESCRIPTION OF THE PREFERRED EMBODIMENTS

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements.

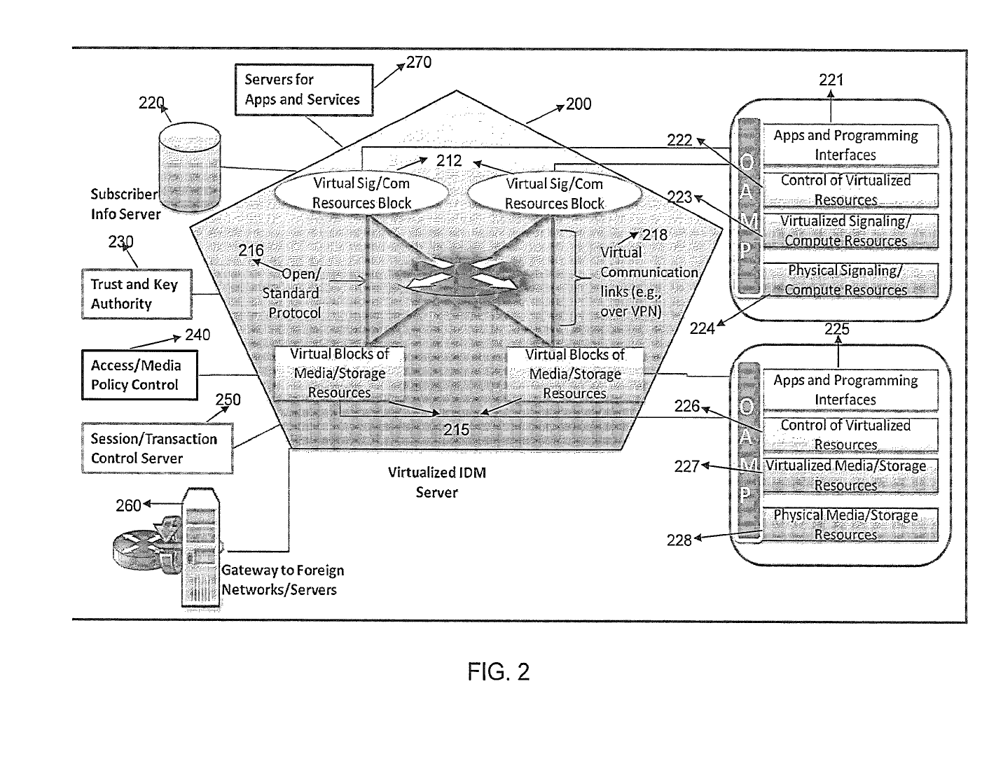

FIG. 2 shows one embodiment of the IDM implementation model of this invention. In this implementation, the IDM features and functions are implemented on one or more virtual IDM servers 210. Such a virtual IDM server may be designed to utilize a set of resources in the network on a real-time and on-demand basis. The resources can be obtained from public, private or community networks. In one embodiment, such a virtual server may be implemented as a cloud-based virtual IDM server by configuring existing cloud-computing resources to provide IDM services. Such an implementation may be achieved by designing IDM application interfaces (APIs) or resource programming interfaces (RPIs) using programming languages that are well-known in the art. For example, these AIPs/RPIs can use any one or more of the following: SOAP, XML, WSDL, Parlay/Parlay-X, HTTP, CORBA, etc. The design of these APIs/RPIs may be based on existing cloud-computing platforms such as the Amazon Elastic Compute Cloud (Amazon EC2). Information about Amazon EC2 can be obtained from the EC2 website at http://aws.amazon.com/ec2/. The content of this website is incorporated herein.

Note that these APIs/RPIs not only simplify access to the desired resources but also guarantee rapid integration and interoperability with the existing network/infrastructure, security, availability, service continuity, etc. This is due to the fact that the desired IDM features/functions are obtained by shopping around the available networked resources through these open APIs/RPIs, and fetching them so that these can be utilized per the requirements of the applications and services for the duration of the service. For example, real-time availability of firewalling and encryption Key resources is mandatory for real-time Enterprise secure voice communications services over the public Internet.

In one embodiment, the virtual IDM server 210 further comprises a set of virtual signaling/compute resource blocks 212 and a set of virtual media/storage resource blocks 215. The virtual signaling/compute resource blocks 212 receive the IDM service and process requests from the APIs/RPIs, and allocate or obtain media/storage resources (such as storage space, computing capacity, etc.) from the virtual blocks of media/storage resources 215 through open/standard protocols 216 or virtual communication links (VPNs) 218. The virtual blocks of media or signaling resources may be obtained from a variety of networked resources, and utilized for any extended duration of the requirements. In one embodiment, this duration of usage may vary from a few hours to a few days.

In one embodiment, the blocks of virtual signaling/compute resources 212 that are obtained from a variety of networked sources are integrated into a pool of IDM signaling resources, and an unified API 221 is created for accessing this pool of IDM signaling resources. This provides a way for the IDM service to be easily available to the applications and services, such as Subscriber info/profile Server 220, Trust and Key Authority 230, Access/Media Policy Control 240, Session/Transaction Control Server 250, etc, to communicate with the signaling part of IDM.

In another embodiment, the signaling part of the IDM implementation also comprises one or more modules 222 for controlling or allocating the signaling resources needed to process the IDM service request. The physical signaling/compute resources 224 may exist in a variety of computers in a distributed fashion and existing cloud computing techniques may be utilized to integrate these distributed resources as a virtual resource 223 to ease the communication between control modules 222 and physical resources 224.

In yet another embodiment, the signaling part of the IDM implementation also controls the allocation of resources from the media control part of IDM through virtual network links using either open protocol 216 or VPNs 218.

In yet another embodiment, the resource blocks for the media part of IDM may also be obtained from a variety of networked sources and these blocks may be integrated into a pool of IDM media resources, and an unified API 225 for accessing the pool of IDM media resources may be created to ease the communication between the signaling part and the media part of IDM.

In one embodiment, the media part of the IDM implementation also comprises one or more modules 226 for controlling or allocating the media resources needed to process the IDM service request. The physical media/storage resources 228 may exist in a variety of computers in a distributed fashion and existing cloud computing techniques may be utilized to integrate these distributed resources as a virtual resource 227 to ease the communication between control modules 226 and physical resources 228.

The signaling or media resources that are required for processing the IDM service request may be obtained from a variety of networked resources, and utilized for the required duration. The duration may vary from a few minutes to tens or hundreds of hours.

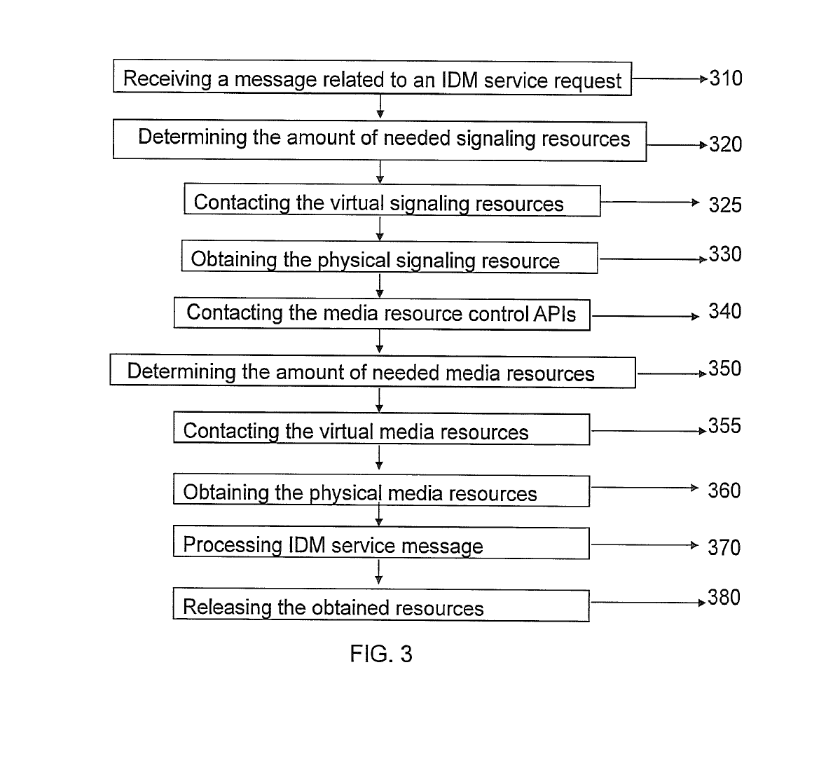

FIG. 3 shows a method of providing IDM services according to one embodiment of the present invention. In this embodiment, a message related to an IDM service request is first received by the signaling APIs of the IDM implementation in step 310. Such a request message may originate from Subscriber info/profile Server 220, Trust and Key Authority 230, Access/Media Policy Control 240, or Session/Transaction Control Server 250, etc. In step 320, the control module of the signaling part of this IDM implementation determines the amount of needed signaling resources and the amount of time the required resources are needed. In step 325, the signaling control module contacts the virtual signaling resource to request allocation of signaling resources, and such resources are obtained in step 330.

Then in step 340, the signaling part of the IDM implementation contacts the media resource control APIs to request an allocation of the media resources. As described above, both the signaling APIs and the media control APIs may be designed using based on existing cloud computing platforms. In step 350, the control module of the media part of this IDM implementation determines the amount of needed signaling resources and the amount of time the required resources are needed. In step 355, the signaling control module contacts the virtual media resources to request allocation of signaling resources, and such resources are obtained in step 360.

Then, in step 370, the IDM service request message is processed using the obtained resources. The retention of signaling and media resources and processing of IDM requests may be achieved by utilizing existing cloud-computing services such as the Amazon EC2. Finally, the signaling and media resources are released in step 380 after the IDM service request is processed.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A virtual IDM server, said server utilizing a plurality of shared resources residing on a plurality of computers in one or more computer networks; said server also controlling the allocation and usage of said shared resources on a real-time basis; said server further comprising: one or more APIs for receiving messages related to IDM service requests; and one or more APIs for accessing a plurality of said shared resources on a real-time basis during processing of said IDM service requests.

2. The virtual IDM server of claim 1, further comprising a signaling control module; said signaling control module controlling the allocation and usage of said shared resources by communicating with one or more virtual signaling resources APIs.

3. The virtual IDM server of claim 2, further comprising a media control module, said media control module controlling the allocation and usage of said shared resources by communicating with one or more virtual media resources APIs.

4. The virtual IDM server of claim 1, further comprising a virtual signaling portion and a virtual media portion, said virtual signaling portion and virtual media portion communicate through standard network protocol or VPN.

5. The virtual IDM server of claim 1, wherein one or more of the APIs are designed based on a cloud computing platform.

6. The virtual IDM server of claim 1, wherein the shared resources are fetched and released based on the requirements of the IDM service request.

7. A computer network comprising the virtual IDM server of claim 1.

8. The virtual IDM server of claim 1, wherein the one or more APIs comprise a unified API for all shared resources.

9. The virtual IDM server of claim 1, wherein the shared resources comprising resources residing in one or more public or community computer networks.

10. A method for providing IDM services, comprising: receiving messages related to requests for IDM service; determining the allocation and usage of a plurality of shared resources on a real-time basis, said shared resources residing in a plurality of computers in one or more computer networks; and communicating with one or more APIs for accessing said shared resources on a real-time basis during processing of said IDM service requests.

11. The method of claim 10, wherein the step of determining further comprising determining the allocation and usage of signaling resources on a real timer basis.

12. The method of claim 10, wherein the step of determining further comprising determining the allocation and usage of media resources on a real timer basis.

13. The method of claim 10, wherein the step of communicating further comprising communicating with one or more virtual signaling APIs to access shared resource for signaling.

14. The method of claim 10, wherein the step of communicating further comprising communicating with one or more virtual media APIs to access shared resource for media usage.

15. The method of claim 13, wherein the one or more APIs comprise a unified API for accessing all shared resources.

16. The method of claim 13, wherein one or more of the APIs are designed based on a cloud computing platform.

17. The method of claim 10, wherein the shared resources are fetched and released based on the requirements of the IDM service request.

18. The method of claim 10, wherein the shared resources comprising resources residing in one or more public or community computer networks.

19. The method of claim 14, wherein the one or more APIs comprise a unified API for accessing all shared resources.

20. The method of claim 14, wherein one or more of the APIs are designed based on a cloud computing platform.
